(19) United States
(12) Patent Application Publication
(10) Pub. No.: US 2010/0115993 A1
(43) Pub. Date: May 13, 2010

(54) PROCESS FOR REMOVING MERCAPTANS FROM LIQUEFIED NATURAL GAS

(76) Inventors: Anthonius Maria Demmers, Amsterdam (NL); Sander Kaart, The Hague (NL); Adriaan Johannes Kodde, Amsterdam (NL)

Correspondence Address: SHELL OIL COMPANY, P O BOX 2463, HOUSTON, TX, 772522463, US

(21) Appl. No.: 12/446,583

(22) PCT Filed: Oct. 23, 2007
(86) PCT No.: PCT/EP07/61327

§ 371 Date: Apr. 22, 2009

(30) Foreign Application Priority Data
Oct. 24, 2006 (EP) 06122836.7

(51) Int. Cl. F25J 3/02; B01D 53/52

(52) U.S. Cl. 62/619

(57) ABSTRACT

The invention provides a process for producing purified natural gas, the process comprising the steps of: expanding a pressurised natural gas stream comprising at least 4 ppmv of mercaptans and supplying it to a first separation column, in which the natural gas stream is separated into a gaseous overhead stream enriched in methane and a first fraction enriched in mercaptans; withdrawing the gaseous overhead stream enriched in methane from the separation column to obtain the purified natural gas; with drawing the fraction enriched in mercaptans from the separation column; removing mercaptans from the first fraction enriched in mercaptans.

The invention relates to a process for producing purified natural gas.

Generally, natural gas comprises mainly methane and can further comprise other components such as higher hydrocarbons (e.g. ethane, propane, butanes, pentanes), nitrogen, carbon dioxide, sulphur contaminants and mercury. The amount and type of sulphur contaminants can vary. Common sulphur contaminants are hydrogen sulphide (H₂S), mercaptans (RSH) and carbonyl sulphide (COS).

Processes for producing purified natural gas generally involve removal of contaminants and of compounds other than methane from a feed natural gas stream to low levels, after which the resulting purified natural gas is cooled to form LNG.

When the purified natural gas is intended to be cooled to liquefied natural gas (LNG), removal of carbon dioxide, water and sulphur compounds is required.

A conventional process for producing purified natural gas is outlined in the paper “Integrated Treating Options for Sour Natural Gases” presented on the GPA conference, 20-22 September 2006 by T. J. Brok. In this process, a feed natural gas stream is led to an acid gas removal unit, where carbon dioxide as well as part of the mercaptans is removed. The resulting gas stream is led to a molecular sieve unit, where water and mercaptans are removed to low levels. The gas stream exiting the molecular sieve unit is led to a mercury removal unit, where mercury removal takes place. The gas exiting the mercury removal unit now comprises very little contaminants, in particular mercaptans. Typically, the amount of mercaptans in this gas stream is below 1 ppmv for each type of mercaptan compound. This gas stream is supplied to a separation column where methane is separated and withdrawn as a gaseous overhead stream and cooled to form LNG. The remaining part of the gas stream is subjected to further extraction steps to separate remaining hydrocarbons.

The process described hereinabove has several drawbacks.

Firstly, it results in a molecular sieve bed loaded with mercaptans. Removal of mercaptans from the molecular sieve bed is needed, usually by contacting the molecular sieve bed with a stripping gas. The resulting stripping gas is loaded with mercaptans and needs to be treated, typically using an absorption process step, in order to be used again. Thus, the overall process involves many steps.

Secondly, when substantial amounts of mercaptans are present in the feed natural gas, large molecular sieve beds have to be employed. The use of such large molecular sieve adsorbent bed and the accompanying regeneration steps requires additional capital investments for equipment and additional operation measures are needed.

Thirdly, removal of part of the mercaptans in the acid gas removal unit will almost inevitably lead to co-absorption of valuable hydrocarbons.

Finally, in the overall scheme mercaptan removal is required both in the natural gas as well as in each liquid product stream (ethane, propane, butane and gasoline). The reason for this is that the extraction of methane from the natural gas stream (in the demethaniser) results in a concentration of the residual levels of mercaptans to such an extent that the fractionated products (ethane, propane, butane and gasoline) do not fulfil the product specifications with regard to the maximum amount of sulphur contaminants allowed without additional removal of mercaptans (also referred to as “sweetening”). Thus, mercaptan removal needs to be done at several stages in the overall process.

The above-mentioned problems are partly overcome by the process for liquefying natural gas containing mercaptans described in U.S. Pat. No. 5,659,109. In this process, mercaptans are concentrated into a distillate stream by distilling the natural gas stream in a refluxed scrub column, followed by fractionating the bottom streams from the scrub column into a liquids stream comprising pentane and heavier hydrocarbons and one or more overhead streams comprising ethane, propane and butane and removing mercaptans from at least one of the overhead streams to form a mercaptan-lean stream. A disadvantage of the process described in U.S. Pat. No. 5,659,109 is that a recycle of the liquid stream to the scrub column is needed. This results in an increase in the diameter of the fractionation stage column and an increase in refrigeration power needed. Furthermore, a larger mercaptan removal unit is required. Another disadvantage is that up to four separate mercaptan removal units will be needed in order to meet the sulphur specifications of the fractionated products. The design and sizing of the mercaptan removal units (sweetening units) are very sensitive to the predicted recovery of mercaptans in the various streams. Consequently the overall design is very sensitive to the level and speciation of organic sulphur species, in particular mercaptans, in the feed natural gas stream.

Therefore, there remains a need in the art for a simplified process for the production of purified natural gas with lower capital investment costs and without the drawbacks mentioned.

To this end, the invention provides a process for producing purified natural gas, the process comprising the steps of:

(a) expanding a pressurised natural gas stream comprising at least 4 ppmv of mercaptans and supplying the resulting de-pressurised natural gas stream to a first separation column, in which first separation column the natural gas stream is separated into a gaseous overhead stream enriched in methane and a first fraction enriched in mercaptans;
(b) withdrawing the gaseous first separation column overhead stream enriched in methane from the separation column to obtain the purified natural gas;
(c) withdrawing the fraction enriched in mercaptans from the separation column;
(d) optionally supplying the withdrawn fraction comprising mercaptans to a second separation column, in which second separation column the fraction comprising mercaptans is separated into an overhead stream enriched in ethane and a second fraction enriched in mercaptans;
(e) removing mercaptans either from the first fraction enriched in mercaptans or from the second fraction enriched in mercaptans.

In the process, fractionation is preceded by expansion of the gas. The advantage of fractionation at lower pressure is that a better separation of natural gas into the various hydrocarbons is achieved. Furthermore, the temperature decrease achieved by expanding the gas greatly facilitates the recovery of C2+ hydrocarbons (ethane and higher) as well as mercaptan compounds in the bottom stream. Thus, there will be no need for additional mercaptan removal at lateg stages in the process.

No dedicated mercaptan removal is done upstream of the first separation column. This is reflected in the amount of mercaptans in the natural gas stream supplied to the first separation column of at least 4 ppmv of mercaptans, which constitutes a substantial amount of mercaptans. By removing mercaptans downstream of the first separation column, no expensive and cumbersome operation of a large molecular sieve unit for mercaptan removal upstream the first separation column is needed. Rather, mercaptan removal can now be done on a relatively small volumetric flow, preferably using an inexpensive and simple method such as caustic treating or hydrotreating. Moreover, the process does not require regeneration of stripping gas used to remove mercaptans from a molecular sieve bed comprising mercaptans. In prior art processes, this regeneration is usually done via an acid gas removal step, resulting in co-absorption of hydrocarbons. In the current process, further loss of valuable hydrocarbons through co-absorption in an acid gas removal step of the molecular sieve stripping gas is avoided.

It will be understood that the amount of mercaptans in the natural gas stream supplied to the separation column can vary and will depend on the amount of mercaptans in the feed natural gas stream derived from the natural gas field. Generally, the amount of mercaptans in the natural gas stream supplied to the first separation column is in the range of from 4 ppmv to 5 volume %, preferably from 5 ppmv to 5 volume %, more preferably from 6 ppmv to 5 volume %, still more preferably from 10 ppmv to 5 volume %, based on the total natural gas stream supplied to the first separation column. When mercaptans are present in the preferred ranges, the cost-saving aspect of performing mercaptan removal downstream the separation column is even higher.

Suitably, the natural gas stream supplied to the separation column is depleted in water and depleted in carbon dioxide. Preferably the natural gas stream supplied to the separation column comprises less than 1 volume %, more preferably less than 50 ppmv and still more preferably less than 10 ppmv of carbon dioxide, based on the total natural gas stream supplied to the first separation column.

Optionally, the natural gas stream supplied to the first separation column comprises carbonyl sulphide (COS). The concentration of COS, if applicable, is suitably in the range of from 1 to 30, preferably from 1 to 10 and more preferably from 1 to 5 ppmv, based on the total natural gas stream supplied to the first separation column.

Optionally, the natural gas stream supplied to the separation column is depleted in mercury, preferably comprising less than 10 nanograms per cubic meter of gas at standard conditions of mercury. This is especially preferred in the event that the natural gas stream is intended to produce liquefied natural gas (LNG).

The amount of mercaptans and other contaminants in the natural gas stream supplied to the first separation column will translate into higher concentrations of these contaminants downstream the first separation column. Thus, if removal of these contaminants is not done to low levels, further treatment downstream the first separation column will often be necessary.

The pressurised natural gas stream supplied to the separation column is suitably at a pressure in the range of from 30 to 75 bara. In step (a), the pressurised natural gas stream is expanded, resulting in a de-pressurised natural gas stream. It will be understood that the extent of expansion is dependent on various factors, among which the composition of the natural gas and the desired contaminant concentrations of the purified natural gas. Without wishing to restrict the invention to a specific range, it has been found that a pressure difference between the pressurised natural gas and the de-pressurised natural gas of at least 10 bara, preferably at least 15 bara, more preferably at least 20 bara results in a good separation. The first separation column is preferably operated at a pressure in the range of from 20 to 60 bara, preferably from 20 to 40 bara.

The natural gas stream supplied to the separation column is suitably at a temperature in the range of from −85 to 0° C.

In the first separation column the natural gas stream is separated into a gaseous overhead stream enriched in methane and a fraction enriched in mercaptans. The gaseous overhead stream enriched in methane is withdrawn from the separation column to obtain the purified natural gas. The purified natural gas can be processed further in known manners. For example, the purified natural gas can be subjected to catalytic or non-catalytic combustion, to generate electricity, heat or power, or can be used converted to synthesis gas or can be applied for residential use.

Preferably, the purified natural gas is cooled to obtain liquefied natural gas (LNG) as for example described in WO 99/60316 or WO 00/29797, the contents of which patent applications are incorporated herein. Therefore, the invention also provides LNG formed by cooling the purified natural gas obtained by the process according to the invention.

The composition of the first fraction enriched in mercaptans and optionally enriched in COS can vary and depends inter alia on the operation conditions of the first separation column. Preferably, the first fraction enriched in mercaptans and optionally enriched in COS is essentially free of methane, meaning that the first fraction enriched in mercaptans and optionally enriched in COS comprises at most 5 mol %, preferably at most 1 mol % of methane.

It will be understood that the amount of mercaptans in the first fraction enriched in mercaptans and optionally enriched in COS will depend on the amount of mercaptans in the natural gas stream supplied to the first separation column. Preferably, the first fraction enriched in mercaptans and optionally enriched in COS comprises in the range of from 100 ppmv to 5 volume %, more preferably from 500 ppmv to 5 volume % of mercaptans.

The amount of COS in the first fraction enriched in mercaptans and optionally enriched in COS, if applicable, is suitably in the range of from 5 to 150, preferably from 5 to 100 and more preferably from 5 to 50 ppmv, based on the total first fraction enriched in mercaptans and optionally enriched in COS.

Suitably, the concentration of CO₂ in the first fraction enriched in mercaptans and optionally enriched in COS is below 50 ppmv.

In one preferred embodiment, the first fraction enriched in mercaptans and optionally enriched in COS is also enriched in C₂+ hydrocarbons. Reference herein to C₂+ hydrocarbons is to hydrocarbons having 2 or more carbon atoms. Preferably, the first fraction enriched in mercaptans and optionally enriched in COS comprises at least 30 mol %, more preferably at least 60 mol %, most preferably at least 80 mol % of C₂+ hydrocarbons. In this preferred embodiment, the first separation column is suitably operated at a pressure in the range of from 20 to 40 bara, preferably from 25 to 35 bara.

The first fraction enriched in mercaptans and optionally enriched in COS is withdrawn from the separation column, preferably as a bottom stream.

In a preferred embodiment, the withdrawn first fraction enriched in mercaptans and optionally enriched in COS is subjected to a mercaptan and optionally COS removal step, resulting in a first fraction depleted in mercaptans and optionally in COS. This first fraction depleted in mercaptans and optionally in COS is then supplied to a second separation column. In the second separation column, the first fraction depleted of mercaptans and optionally in COS is separated into a second gaseous overhead stream and a second fraction depleted in mercaptans and optionally in COS.

In this preferred embodiment, the first fraction enriched in mercaptans and optionally in COS is supplied to the second separation column at a temperature in the range of from 40 to 100° C. and at a pressure in the range of from 10 to 40 bara.

Preferably, the second fraction depleted in mercaptans is essentially free of ethane, meaning that the second fraction depleted in mercaptans comprises at most 5 mol %, preferably at most 1 mol % of ethane. Preferably, the second fraction depleted in mercaptans is enriched in C₃+ hydrocarbons. Reference herein to C₃+ hydrocarbons is to hydrocarbons having 3 or more carbon atoms. Preferably, the second fraction depleted in mercaptans comprises at least 30 mol %, more preferably at least 60 mol %, most preferably at least 80 mol % of C₃+ hydrocarbons. In this preferred embodiment, the second separation column is suitably operated at a pressure in the range of from 10 to 40 bara, preferably from 12 to 18 bara.

The second fraction depleted in mercaptans and preferably enriched in C₃+ hydrocarbons may be subjected to further fractionation steps, for example in a third separation column to obtain a fraction depleted in mercaptans and preferably enriched in C₄+ hydrocarbons. Reference herein to C₃+ hydrocarbons is to hydrocarbons having 4 or more carbon atoms.

Removal of mercaptans from the withdrawn first fraction results in a fraction depleted in mercaptans and enriched in C₂+ hydrocarbons. As a consequence, the second fraction and all further fractions will also be depleted in mercaptans. Thus, only one fraction needs to be treated to remove mercaptans and no separate mercaptan removal on the subsequent individual fractions is needed.

Another advantage of removing mercaptans from the withdrawn first fraction is that it avoids or reduces the need for mercaptan removal at later stages in the process. It is known that organic sulphur components present in a typical natural gas stream distribute over the various product streams during their fractionation. This is for example extensively described in Chapter 8 (liquid sweetening) of “Gas Conditioning and processing, Volume 4: gas treating and sulphur recovery, by J. M. Campbell. Thus, all product streams from the natural gas and liquid recovery unit will be contaminated with mercaptans to such a level that further mercaptan removal is required. By removing mercaptans from the first fraction, the need for mercaptan removal from products streams is avoided or reduced.

In another embodiment, the first fraction enriched in mercaptans and optionally enriched in COS is supplied to a second separation column column without removing mercaptans. In this embodiment, in the second separation column the first fraction enriched in mercaptans and optionally enriched in COS is separated into a gaseous second overhead stream enriched in ethane and a second fraction enriched in mercaptans. The second fraction enriched in mercaptans is withdrawn from the second separation column, preferably as a bottom stream. The withdrawn second fraction enriched in mercaptans is then subjected to a mercaptan removal step. Removal of mercaptans from the second separation column fraction enriched in mercaptans results in a second fraction depleted in mercaptans. Further fractionation will result in fractions depleted of mercaptans. This embodiment offers the additional advantage that mercaptan removal is done on a smaller fraction. In the event that the second overhead stream also comprises carbonyl sulphide (COS), the second overhead stream is preferably subjected to a COS removal step.

It will be understood that the amount of mercaptans in the second fraction enriched in mercaptans will depend on the amount of mercaptans in the fraction supplied to the separation column. Preferably, the second fraction enriched in mercaptans comprises in the range of from 150 ppmv to 5.5 volume %, more preferably from 550 ppmv to 5.5 volume % of mercaptans.

Preferably, the second fraction enriched in mercaptans is essentially free of ethane, meaning that the second fraction enriched in mercaptans comprises at most 5 mol %, preferably at most 1 mol % of ethane. Preferably, the second fraction enriched in mercaptans is also enriched in C₃+ hydrocarbons. Reference herein to C₃+ hydrocarbons is to hydrocarbons having 3 or more carbon atoms. Preferably, the second fraction enriched in mercaptans comprises at least 30 mol %, more preferably at least 60 mol %, most preferably at least 80 mol % of C₃+ hydrocarbons. In this preferred embodiment, the second separation column is suitably operated at a pressure in the range of from 10 to 40 bara, preferably from 12 to 18 bara.

It will be clear that the invention also includes an embodiment wherein the first fraction enriched in mercaptans and optionally enriched in COS is divided into two parts. One part of the first fraction enriched in mercaptans and optionally enriched in COS is subjected to mercaptan removal prior to being supplied to a second separation column column whereas the remaining part of the first fraction enriched mercaptans is supplied directly to a second separation column.

Reference herein to mercaptans (RSH) is to aliphatic mercaptans, especially C₁-C₆ mercaptans, more especially C₁-C₄ mercaptans, aromatic mercaptans, especially phenyl mercaptan, or mixtures of aliphatic and aromatic mercaptans.

The invention especially involves removal of methyl mercaptan (R=methyl), ethyl mercaptan (R=ethyl), normal- and iso-propyl mercaptan (R=n-propyl and iso-propyl) and butyl mercaptan (R=butyl) isomers.

Two methods for removal of mercaptans are preferred. In the first mercaptan removal method, mercaptans are removed by contacting the fraction enriched in mercaptans with a hydroxide solution, for example sodium hydroxide or potassium hydroxide or a mixture of these. Such a method is described for example in R. N. Maddox and D. J. Morgan in “Gas Conditioning and Processing”, volume 4: Gas Treating and Liquid Sweetening, Campbell Petroleum Series, Norman, Oklahoma, 1998. Without wishing to be bound to a specific theory on the mechanism of mercaptan removal, it is believed that mercaptide compounds are formed and that at least part of these mercaptide compounds are converted to obtain di-sulphide compounds according to reactions (1) and (2).

R-SH+NaOH [symbol] R-SNa+H₂O (1)

4R-SNa+2H₂O₂ [symbol] 2RSSR+4NaOH (2)

In addition, hydrogen sulphide (H₂S) and COS, if present, will also be converted according to reactions (3) and (4).

H₂S+2NaOH [symbol] Na₂S+2H₂O (3)

COS+H₂O [symbol] CO₂+H₂S (4)

Subsequently the Na₂S and CO₂ are converted according to reactions (5) and (6).

2Na₂S+H₂O+2O₂ [symbol] Na₂S₂O₃+2NaOH (5)

CO₂+2NaOH [symbol] Na₂CO₃+H₂O (6)

In the second mercaptan removal method, mercaptans are removed by contacting the fraction enriched in mercaptans with a hydrodesulphurisation catalyst in the presence of hydrogen to obtain hydrogen sulphide. Suitably, this hydrodesulphurisation reaction is performed in a hydrodesulphurisation unit comprising one or more beds of a hydrodesulphurisation catalyst. Fixed beds of hydrodesulphurisation are preferred because they allow a relatively simple operation and maintenance. Alternatively, the fraction enriched in mercaptans may also be contacted with a hydrodesulphurisation catalyst in a slurry reactor.

In the hydrodesulphurisation reaction, mercaptans (RSH) are catalytically converted to H₂S according to reaction (7).

RSH+H₂→H₂S+RH (7)

R is an alkyl group, preferably selected from the group of methyl, ethyl, n-propyl, i-propyl and butyl.

The resulting gas stream enriched in H₂S may be subjected to further treatment to remove H₂S.

Alternatively, the stream exiting the hydrodesulphurisation unit is sent to a separator to obtain a hydrogen-rich gas stream and a stream enriched in H₂S. The hydrogen-rich gas stream may then be re-used in the hydrodesulphurisation reaction. This minimises the presence of H₂ in the second hydrocarbonaceous gas stream. Furthermore, the relatively expensive H₂ is not wasted.

Suitably, the hydrodesulphurisation is performed at a temperature in the range of from 100 to 500° C., preferably from 250 to 400° C., more preferably from 280 to 350° C. and still more preferably from 290 to 330° C.

Better conversion rates at a favourable temperature level are achieved in the preferred temperature ranges.

Suitably, the hydrodesulphurisation is performed at a pressure in the range of from 1 to 100 bara, preferably from 10 to 80 bara, more preferably from 20 to 80 bara.

Any hydrodesulphurisation catalyst known in the art may be used. Typically, the hydrodesulphurisation catalyst comprises a Group VIII and a Group VIB hydrogenation metal, such as cobalt-molybdenum, nickel-molybdenum or nickel-tungsten, and optionally a catalyst support, for example alumina, titania, silica, zirconia or mixtures thereof. Alumina and silica-alumina are preferred. These hydrodesulphurisation catalysts have been found to show a high activity for the conversion of mercaptans to H₂S. Preferably, the hydrodesulphurisation catalyst comprises cobalt and molybdenum or tungsten as hydrogenation metals, since these catalysts have been found to effect optimal conversion of the mercaptans in the first gas stream.

In a preferred embodiment, the natural gas stream comprising mercaptans and depleted in carbon dioxide is obtained by the steps of:

(i) contacting a feed stream comprising natural gas, hydrogen sulphide, carbon dioxide, water, mercaptans and optionally COS with an absorbing liquid in an acid gas removal unit to remove hydrogen sulphide, carbon dioxide and optionally COS to obtain a natural gas stream comprising water and mercaptans;
(ii) contacting the natural gas stream obtained in step (i) with a zeolite molecular sieve adsorbent in a water removal unit to remove water to obtain the natural gas stream comprising mercaptans.

Preferably, the feed gas stream comprises mainly methane and may further comprise varying amounts of hydrocarbons comprising more than 1 carbon atom, such as ethane, propanes, butanes and pentanes. The feed gas stream may further comprise other non-hydrocarbon compounds such as nitrogen and mercury. The feed gas stream may comprise varying amounts of mercaptans.

Reference herein to an acid gas removal unit is to a gas-treating unit wherein removal of hydrogen sulphide, carbon dioxide and optionally COS takes place. Acid gas removal is achieved using one or more solvent formulations based on an aqueous amine solvent. A large part of the H₂S and carbon dioxide is transferred from the feed gas stream to the solvent. This results in a solvent enriched in H₂S and carbon dioxide. The acid gas removal step will usually be carried out in a continuous mode, which also comprises regeneration of the enriched absorbing liquid. Enriched absorbing liquid is regenerated by transferring at least part of the contaminants to a stripping gas stream, typically at relatively low pressure and high temperature. Preferably, the enriched absorbing liquid is contacted counter currently with the stripping gas stream. The regeneration results in a regeneration gas stream enriched in H₂S and carbon dioxide.

Preferably, the absorbing liquid is an aqueous solution comprising an aliphatic alkanolamine and a primary or secondary amine as activator. Suitable aliphatic alkanolamines include tertiary alkanolamines, especially triethanolamine (TEA) and/or methyldiethanolamine (MDEA). Suitable activators include primary or secondary alkanolamines, especially those selected from the group of piperazine, methylpiperazine and morpholine. Preferably, the absorbing liquid comprises in the range of from 1.0 to 5 mol/l, more preferably from 2.0 to 4.0 mol/l of aliphatic alkanolamine. Preferably, the absorbing liquid comprises in the range of from 0.5-2.0 mol/l, more preferably from 0.5 to 1.5 mol/l of the primary or secondary amine as activator. Especially preferred is an absorbing liquid comprising MDEA and piperazine. Most preferred is an absorbing liquid comprising in the range of from 2.0 to 3.0 mol/l MDEA and from 0.8 to 1.1 mol/l piperazine. It has been found that the preferred absorbing liquids effect an efficient removal of carbon dioxide and hydrogen sulphide.

The natural gas stream obtained in step (i) is contacted with a zeolite molecular sieve adsorbent in a water removal unit to remove water. Zeolites are solid adsorbents having openings capable of letting a species enter or pass. In some types of zeolites, the opening is suitably defined as a pore diameter whereas in other types the opening is suitably defined as openings in a cage structure. Zeolites having an average opening (pore diameter) of 5 Å or less, preferably an average opening of 3 or 4 Å are preferred. In such zeolites hardly any RSH are adsorbed, mostly water is adsorbed. In general, the selectivity of such zeolites is higher than larger pore zeolites. The amount of water removed may be small or large, but preferably at least 60 wt % of the water is removed, preferably 90 wt %. Very suitably water is removed to a level of less than 1 volume % in the gas stream leaving the water removal unit, preferably to a level less than 100 ppmv, more preferably to a level less than 5 ppmv, most preferably to a level less than 1 ppmv.

The operating temperature of the zeolite adsorbent beds in the water removal unit may vary between wide ranges, and is suitably between 0 and 80° C., preferably between 10 and 40° C., the pressure is suitably between 10 and 150 bara. The superficial gas velocity is suitably between 0.03 and 0.6 m/s, preferably between 0.05 and 0.25 m/s.

Optionally, prior to supplying the natural gas stream comprising mercaptans obtained in step (ii) to the first separation column, mercury is removed by contacting the natural gas stream obtained in step (ii) with a mercury adsorbent.

The invention will now be illustrated with reference to the non-limiting figures.

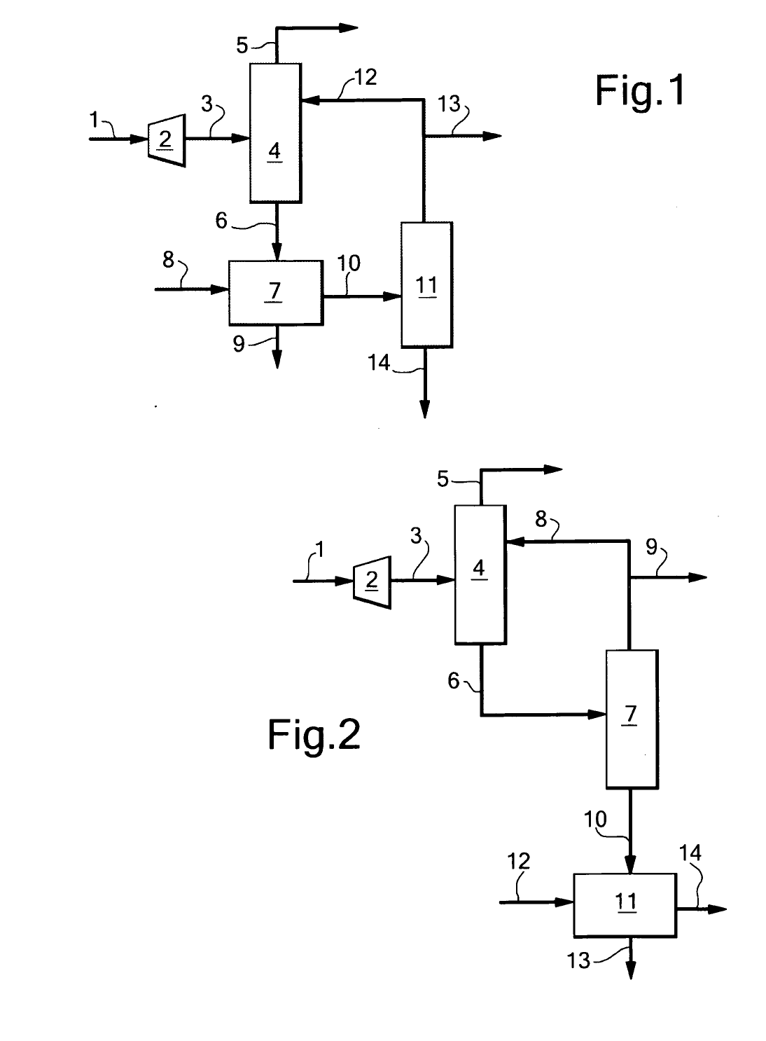

In FIG. 1 an embodiment is shown wherein removal of mercaptans and optionally of COS is done from the first fraction. A pressurised natural gas stream comprising mercaptans is led via line 1 to an expander 2. In expander 2, the pressure is lowered and the de-pressurised natural gas stream is led via line 3 to a first separation column 4. In the first separation column, the natural gas stream is separated into a gaseous overhead stream enriched in methane and a first fraction enriched in mercaptans. The gaseous overhead stream enriched in methane is led from the first separation column via line 5 and preferably cooled to produce LNG or used to produce synthesis gas. The first fraction enriched in mercaptans is led from the first separation column via line 6 to a mercaptan removal unit 7, where mercaptans are removed. Preferably, mercaptan removal takes place via hydrodedulphurisation, wherein the hydrogen needed is supplied to the mercaptan removal unit via line 8. Alternatively, mercaptan removal takes place using a caustic solution, wherein the caustic solution is supplied to the mercaptan removal unit via line 8. Waste products, such as disulphides resulting from a caustic treatment or hydrogen sulphide resulting from a hydrodesulphurisation reaction, are removed from the mercaptan removal unit via line 9. The resulting first fraction, now depleted in mercaptans, is led from the mercaptan removal unit via line 10 to a second separation column 11 where separation into an overhead stream enriched in ethane and a second fraction enriched in propane and higher hydrocarbons takes place. Any methane in the overhead stream enriched in ethane is led from the second separation column via line 12 to the firsts separation column. The ethane is led from the second separation column via line 13, optionally to a hydrogen sulphide removal unit (not shown) where removal of hydrogen sulphide takes place. The second fraction enriched in propane and higher hydrocarbons is led from the second separation column via line 14.

In FIG. 2 an embodiment is shown wherein a second separation column is used and removal of mercaptans and optionally of COS is done from the second fraction. A pressurised natural gas stream comprising mercaptans is led via line 1 to an expander 2. In expander 2, the pressure is lowered and the de-pressurised natural gas stream is led via line 3 to a first separation column 4. In the first separation column, the natural gas stream is separated into a gaseous overhead stream enriched in methane and a first fraction enriched in mercaptans. The gaseous overhead stream enriched in methane is led from the first separation column via line 5 and preferably cooled to produce LNG or used to produce synthesis gas. The first fraction enriched in mercaptans is led from the first separation column via line 6 to a second separation column 7 where separation into an overhead stream enriched in ethane and a second fraction enriched in propane and higher hydrocarbons takes place. Any methane in the overhead stream enriched in ethane is led from the second separation column via line 8 to the first separation column. The ethane is led from the second separation column via line 9. The second fraction enriched in propane and higher hydrocarbons is led from the second separation column via line 10 to a mercaptan removal unit 11, where mercaptans are removed. Preferably, mercaptan removal takes place via hydrodedulphurisation, wherein the hydrogen needed is supplied to the mercaptan removal unit via line 12. Alternatively, mercaptan removal takes place using a caustic solution, wherein the caustic solution supplied to the mercaptan removal unit via line 12. Waste products, such as disulphides resulting from a caustic treatment or hydrogen sulphide resulting from a hydrodeulphurisation reaction, are removed from the mercaptan removal unit via line 13. The resulting first fraction, now depleted in mercaptans, is led from the mercaptan removal unit via line 14.

1. A process for producing purified natural gas, the process comprising the steps of:
(a) expanding a pressurised natural gas stream comprising at least 4 ppmv of mercaptans to yield a depressurized natural gas stream, wherein the pressurised natural gas is expanded to such an extent that the pressure difference between the pressurised natural gas stream and the de-pressurised natural gas stream is at least 10 bara, and supplying the de-pressurised natural gas stream to a first separation column, in which first separation column the depressurized natural gas stream is separated into a gaseous overhead stream enriched in methane and a first fraction enriched in mercaptans.
(b) withdrawing the gaseous overhead stream enriched in methane from the first separation column to obtain purified natural gas;
(c) withdrawing the first fraction enriched in mercaptans from the first separation column and removing mercaptans from the first fraction enriched in mercaptans to yield a first fraction depleted of mercaptans; and
(d) supplying the first fraction depleted of mercaptans to a second separation column, in which second separation column the first fraction enriched in mercaptans is separated into an overhead stream enriched in ethane and a second fraction enriched in mercaptans;
and removing mercaptans from the first fraction enriched in mercaptans.

2. A process according to claim 1, wherein the pressurised natural gas is expanded to such an extent that the pressure difference between the pressurised natural gas and the de-pressurised natural gas is at least 15 bara.

3. A process according to claim 2, wherein the first fraction enriched in mercaptans further comprises C₂+ hydrocarbons.

4. A process according to claim 3, wherein the second fraction enriched in mercaptans further comprises C₃+ hydrocarbons.

5. A process according to claim 4, wherein the natural gas stream comprises at least 5 ppmv mercaptans.

6. A process according to claim 5, wherein mercaptans are removed from the first fraction enriched in mercaptans by contacting it with a hydroxide solution.

7. A process according to claim 6, wherein mercaptans are removed from the first fraction enriched in mercaptans by contacting it with a hydrodesulphurisation catalyst in the presence of hydrogen to obtain hydrogen sulphide.

8. A process according to claim 7, wherein the hydrodesulphurisation catalyst comprises a Group VIII hydrogenation metal, and a Group VIB hydrogenation metal.

9. A process according to claim 8, wherein the pressurised natural gas stream comprising mercaptans is obtained by the steps of:
(i) contacting a feed stream comprising natural gas, hydrogen sulphide, carbon dioxide, water, and mercaptans with an absorbing liquid in an acid gas removal unit to remove hydrogen sulphide, and carbon dioxide to obtain a natural gas stream comprising water and mercaptans;
(ii) contacting the natural gas stream obtained in step (i) with a zeolite molecular sieve adsorbent in a water removal unit to remove water to obtain the natural gas stream comprising mercaptans.

10. A process for producing purified natural gas, the process comprising the steps of:
(a) expanding a pressurised natural gas stream comprising at least 4 ppmv of mercaptans to yield a depressurized natural gas stream, wherein the pressurised natural gas is expanded to such an extent that the pressure difference between the pressurised natural gas stream and the de-pressurised natural gas stream is at least 10 bara, and supplying the de-pressurised natural gas stream to a first separation column, in which first separation column the depressurized natural gas stream is separated into a gaseous overhead stream enriched in methane and a first fraction enriched in mercaptans;
(b) withdrawing the gaseous overhead stream enriched in methane from the first separation column to obtain purified natural gas;
(c) passing the first fraction enriched in mercaptans to a second separation column whereby the first fraction enriched in mercaptans is separated into an overhead stream enriched in ethane and a second fraction enriched in propane;
(d) removing mercaptans from the second fraction enriched in propane.

11. A process according to claim 10, wherein the pressurised natural gas is expanded to such an extent that the pressure difference between the pressurised natural gas and the de-pressurised natural gas is at least 15 bara.

12. A process according to claim 11, wherein the first fraction enriched in mercaptans further comprises C₂+ hydrocarbons.

13. A process according to claim 12, wherein the second fraction enriched in mercaptans further comprises C₃+ hydrocarbons.

14. A process according to claim 13, wherein the natural gas stream comprises at least 5 ppmv.

15. A process according to claim 14, wherein mercaptans are removed from the first fraction enriched in mercaptans by contacting it with a hydroxide solution.

16. A process according to claim 15, wherein mercaptans are removed from the first fraction enriched in mercaptans by contacting it with a hydrodesulphurisation catalyst in the presence of hydrogen to obtain hydrogen sulphide.

17. A process according to claim 16, wherein the hydrodesulphurisation catalyst comprises a Group VIII hydrogenation metal and a Group VIB hydrogenation metal.

18. A process according to claim 17, wherein the pressurised natural gas stream comprising mercaptans is obtained by the steps of:
(i) contacting a feed stream comprising natural gas, hydrogen sulphide, carbon dioxide, water, and mercaptans with an absorbing liquid in an acid gas removal unit to remove hydrogen sulphide, and carbon dioxide to obtain a natural gas stream comprising water and mercaptans;
(ii) contacting the natural gas stream obtained in step (i) with a zeolite molecular sieve adsorbent in a water removal unit to remove water to obtain the natural gas stream comprising mercaptans.
